(19) United States
(12) Patent Application Publication
(10) Pub. No.: US 2025/0030573 A1
(43) Pub. Date: Jan. 23, 2025

(54) SYSTEMS AND METHODS FOR PERSONALIZED HOME AUTOMATION AND DEVICE CONTROL VARIOUS

(71) Applicant: PLUME DESIGN, INC., Palo Alto, CA (US)

(72) Inventors: Damjan PEGAM, Polzela (SI); Miroslav SAMARDZIJA, Mountain View, CA (US)

(21) Appl. No.: 18/355,569

(22) Filed: Jul. 20, 2023

(51) Int. Cl. H04L 12/28

(52) U.S. Cl. CPC H04L 12/282; H04L 12/2829

(57) ABSTRACT

Disclosed are systems and methods that, via the disclosed functionality, can involve receiving, via a wearable device, biometric data associated with a wearer of the wearable device. The systems and methods may additionally include receiving, from a management device communicatively coupled to at least one managed device, data representative of a device state of the at least one managed device. The systems and methods may also include determining, based on the biometric data, a current status of the wearer, and directing, based on the current status of the wearer and the device state, the management device to execute a management action associated with the at least one managed device. Various other systems, methods, and computer-readable media are also disclosed.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for personalized home automation.

FIG. 2 is a block diagram of an example system that implements a system for personalized home automation.

FIG. 3 is a flow diagram of an example method for personalized home automation.

FIG. 4 shows a perspective view of an example smart ring device that may be used in connection with some of the systems and methods disclosed herein.

FIG. 5 shows a floorplan of an example smart home in accordance with some examples disclosed herein.

FIG. 6, FIG. 7, and FIG. 8 show block diagrams of example additional or alternative configurations for systems for personalized home automation.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

Home automation has undergone rapid advancements over the past years, evolving from simple scheduling of lighting or heating to sophisticated networks of intercommunicating devices, often referred to as “smart home” systems. These systems may provide a multitude of services, including automatic control of lighting, temperature, and security systems, as well as managing household appliances. They may enhance comfort, convenience, and security for occupants, while also increasing energy efficiency. However, these benefits come with their own unique set of challenges.

One primary issue is that the functionality of conventional or traditional smart home systems is predominantly reactionary, relying on pre-programmed schedules or manual input from the users. Such conventional or traditional systems lack the ability to adapt dynamically based on real-time user status or preferences. For instance, a heating system might start at a set time, regardless of whether the occupant is home or not, potentially leading to energy wastage. Similarly, an automated lighting system might not adjust effectively to the user's current activities.

The present disclosure is generally directed to systems and methods for personalized home automation. Embodiments of this disclosure may receive, via a wearable device, biometric data associated with a wearer of the wearable device. Embodiments may also receive, from a management device communicatively coupled to at least one managed device, data representative of a device state of the at least one managed device. Embodiments may further determine, based on the biometric data, a current status of the wearer, and may direct, based on the current status of the wearer and the device state, the management device to execute a management action associated with the at least one managed device.

By integrating biometric data gathered through a wearable device, embodiments of the systems and methods disclosed herein may not only determine a current status of the user, but also may direct management devices (e.g., home automation management devices) to execute appropriate actions (e.g., direct managed home automation devices to execute particular actions) based on the user's status and device state. This may result in a truly smart home that anticipates and responds to the user's needs, thereby elevating convenience, efficiency, and overall user experience.

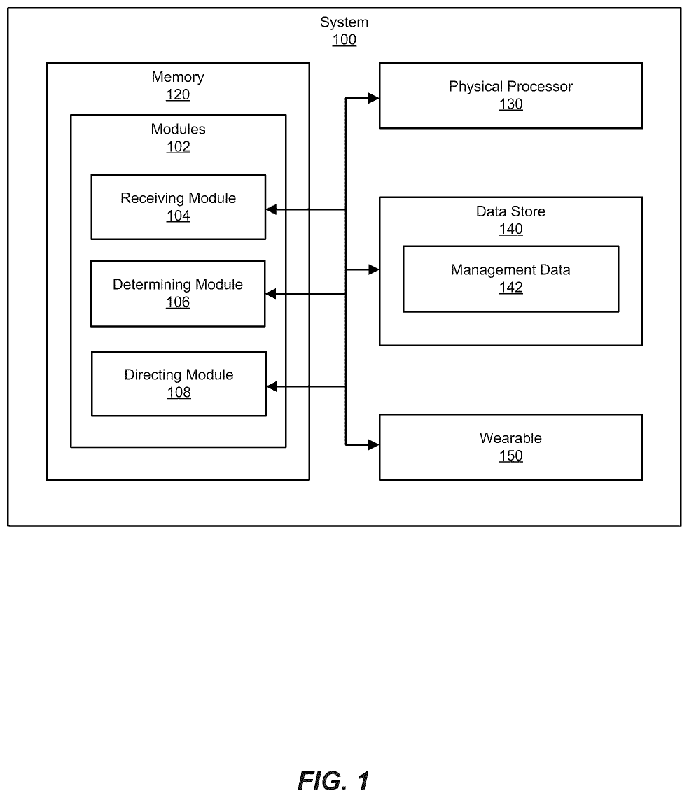

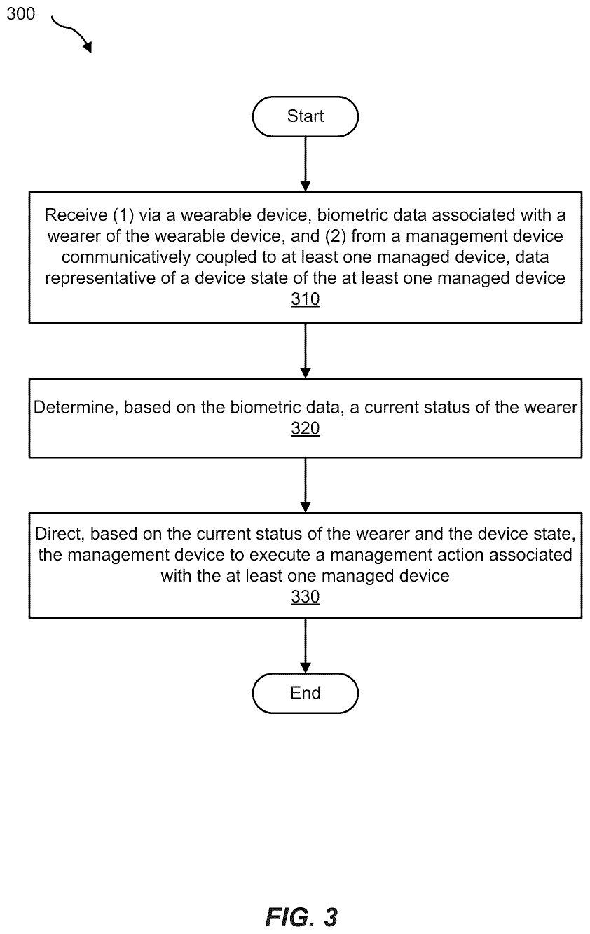

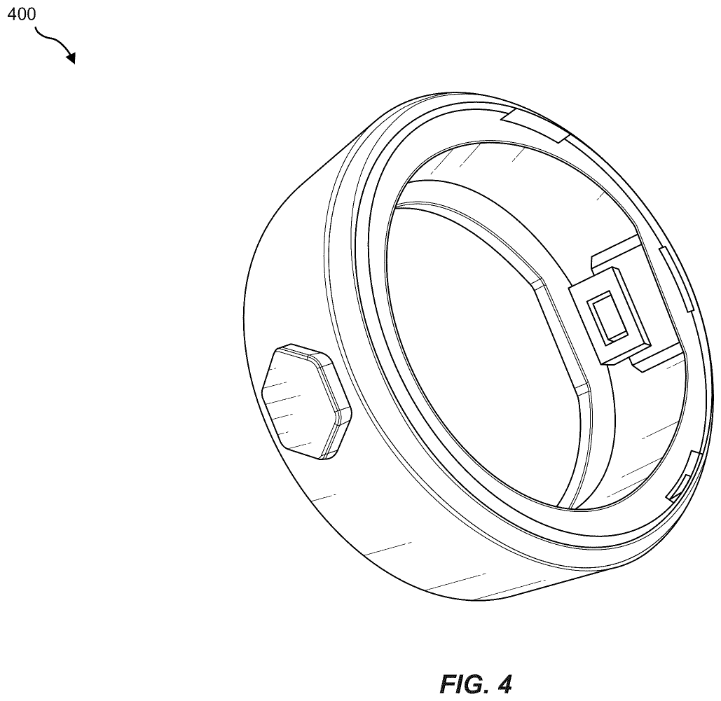

The following will provide, with reference to FIGS. 1-2 and 4-8, detailed descriptions of systems for personalized home automation. Detailed descriptions of corresponding computer-implemented methods will also be provided in connection with FIG. 3.

FIG. 1 is a block diagram of an example system 100 for personalized home automation. As illustrated in this figure, example system 100 may include one or more modules 102 for performing one or more tasks. As will be explained in greater detail below, modules 102 may include a receiving module 104 that may receive, via a wearable device, biometric data associated with a wearer of the wearable device. Furthermore, receiving module 104 may also receive, from a management device communicatively coupled to at least one managed device, data representative of a device state of the at least one managed device.

As also shown in FIG. 1, example system 100 may further include a determining module 106 that may determine, based on the biometric data, a current status of the wearer, and a directing module 108 that may direct, based on the current status of the wearer and the device state, the management device to execute a management action associated with the at least one managed device.

As further illustrated in FIG. 1, example system 100 may also include one or more memory devices, such as memory 120. Memory 120 generally represents any type or form of volatile or non-volatile storage device or medium capable of storing data and/or computer- readable instructions. In one example, memory 120 may store, load, and/or maintain one or more of modules 102. Examples of memory 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As further illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 120. Additionally or alternatively, physical processor 130 may execute one or more of modules 102 to facilitate personalized home automation. Examples of physical processor 130 include, without limitation, microprocessors, microcontrollers, central processing units (CPUs), virtualized processors executed by physical processors, Field-Programmable Gate Arrays (FPGAs) that implement softcore processors, Application-Specific Integrated Circuits (ASICs), portions of one or more of the same, variations or combinations of one or more of the same, or any other suitable physical processor.

As also illustrated in FIG. 1, example system 100 may also include one or more stores of data, such as data store 140. Data store 140 may represent portions of a single data store or computing device or a plurality of data stores or computing devices. In some embodiments, data store 140 may be a logical container for data and may be implemented in various forms (e.g., a database, a file, file system, a data structure, and the like). Examples of data store 140 may include, without limitation, one or more files, file systems, data stores, databases, and/or database management systems such as an operational data store (ODS), a relational database, a NoSQL database, a NewSQL database, and/or any other suitable organized collection of data.

In at least one example, data store 140 may include management data 142 that may include data for managing connected devices, such as one or more application programming interfaces (APIs) for providing commands to and/or receiving data from one or more connected devices, one or more configurations of a set of connected devices, one or more programs for executing one or more management actions, and so forth. By way of illustration, in some examples, management data 142 may include data representative of a configuration of, and/or one or more methods of interacting electronically and/or programmatically with, one or more smart home devices.

In additional or alternative examples, management data 142 may further include biometric information and/or models of biometric information that may enable one or more of modules 102 (e.g., determining module 106) to determine a status of a wearer based on received biometric information or data, as will be described in greater detail below.

As is further shown in FIG. 1, example system 100 may also include a wearable 150. In some examples, a “wearable” or “wearable device” generally includes devices designed and/or intended to be worn by a wearer and/or integrated into clothing. These devices may have the ability to connect to the internet, sync with other devices (e.g., mobile phones, personal computers, tablet computers, and the like) and provide a variety of features including, but not limited to, tracking physical activity (e.g., steps, heart rate, calories burned, and the like), monitoring biometric information (e.g., blood pressure, blood glucose levels, sleep quality, and the like), providing notifications (e.g., voice calls, emails, text messages, reminders, and the like), supporting navigation (e.g., via positioning systems, Wi-Fi, triangulation, and the like), making contactless payments, voice control, and/or gesture recognition.

Smart rings are a specific type of wearable technology that may be worn on a wearer's finger, similar to a traditional ring. They can be designed to provide various functionalities like those mentioned above and are often focused on discrete or minimalist design to maintain an outward style aspect of a ring while adding smart capabilities. Some may even include bio-sensing features such as measuring stress, body temperature, or providing an electrocardiogram (ECG). These features can vary greatly depending on the particular make and model of the smart ring, and hence this disclosure is not limited to any particular wearable device.

In additional or alternative examples, a “wearable” may include any device capable of (1) gathering biometric data of a wearer of the wearable, and (2) transmitting that data to one or more of modules 102 (e.g., receiving module 104), such as a smart ring, a smartphone, an outside-in tracking system, an inside-out tracking system, a computer vision tracking system, and so forth.

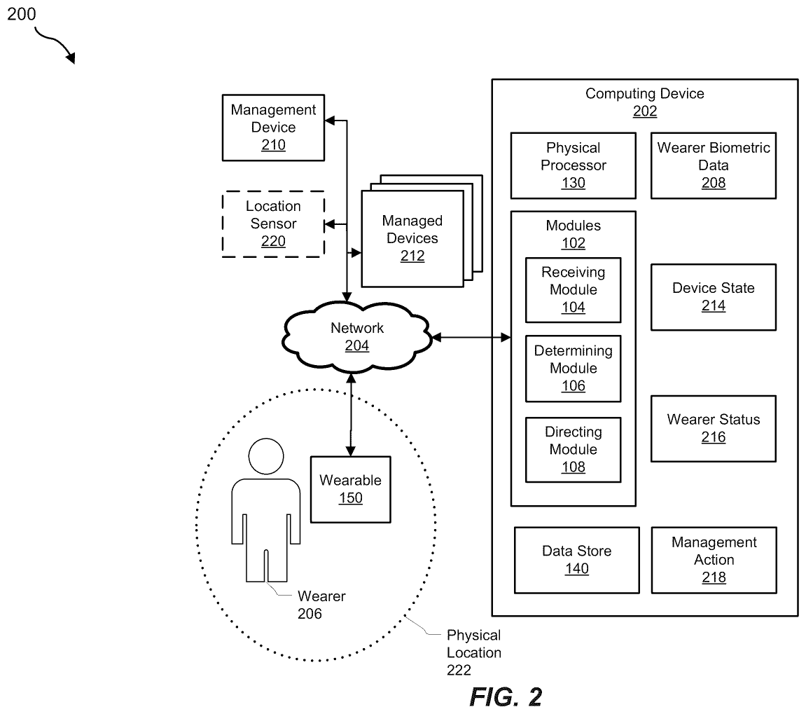

Example system 100 in FIG. 1 may be implemented in a variety of ways. For example, all or a portion of example system 100 may represent portions of an example system 200 (“system 200”) in FIG. 2. FIG. 2 is a block diagram of an example system 200 that implements a system for personalized home automation. As shown in FIG. 2, system 200 may include a computing device 202 in communication with wearable 150 via network 204. In at least one example, computing device 202 may be programmed with one or more of modules 102.

In at least one embodiment, one or more modules 102 from FIG. 1 may, when executed by computing device 202, computing device 202 to perform one or more operations to enable personalized home automation. For example, as will be described in greater detail below, receiving module 104 may cause computing device 202 to receive, via a wearable device (e.g., wearable 150), biometric data associated with a wearer of the wearable device (e.g., wearer biometric data 208 associated with wearer 206). In some examples, receiving module 104 may also cause computing device 202 to receive, from a management device (e.g., management device 210) communicatively coupled to at least one managed device (e.g., at least one of managed devices 212), data representative of a device state of the at least one managed device (e.g., device state 214).

Furthermore, in some examples, determining module 106 may cause computing device 202 to determine, based on the biometric data, a current status of the wearer (e.g., wearer status 216), and directing module 108 may cause computing device 202 to direct, based on the current status of the wearer and the device state, the management device to execute a management action (e.g., management action 218) associated with the at least one managed device.

In some examples, the management device may include or represent a home automation management device. In such examples, one or more of modules 102 (e.g., directing module 108) may direct the management device to execute the management action by directing the home automation management device to direct a smart home device (e.g., at least one of managed devices 212) to execute a smart home function.

In additional examples, one or more of modules 102 (e.g., determining module 106) may further cause computing device 202 to identify, via at least one location sensor (e.g., location sensor 220), a physical location of the wearer (e.g., physical location 222). Moreover, in some examples, one or more of modules 102 (e.g., directing module 108) may further cause computing device 202 to determine the current status of the wearer based on the physical location of the wearer. In some examples, one or more of modules 102 (e.g., directing module 108) may cause computing device 202 to execute the management action associated with the managed device further based on the determined physical location of the wearer.

Computing device 202 generally represents any type or form of computing device capable of reading and/or executing computer-executable instructions. Examples of computing device 202 include, without limitation, servers, desktops, laptops, tablets, cellular phones, (e.g., smartphones), personal digital assistants (PDAs), multimedia players, embedded systems, wearable devices (e.g., smart watches, smart glasses, and the like), gaming consoles, combinations of one or more of the same, or any other suitable mobile computing device.

Network 204 generally represents any medium or architecture capable of facilitating communication and/or data transfer between computing device 202 and one or more other network-enabled devices. For example, the network 204 can be, but is not limited to, a Wi- Fi network, a local area network (LAN), a wide-area network (WAN), and/or any other type of network that can facilitate connectivity among devices at a location and/or with a cloud service (e.g., Bluetooth™M, and the like). Network 204 may facilitate communication or data transfer using wireless or wired connections. Examples of network 204 include, without limitation, an intranet, a WAN, a LAN, a Personal Area Network (PAN), the Internet, Power Line Communications (PLC), a cellular network (e.g., a Global System for Mobile Communications (GSM) network, a code- division multiple access (CDMA) network, a Long-Term Evolution (LTE) network, a Fifth- Generation (5G) network, and the like), universal serial bus (USB) connections, and the like. In some embodiments, network 204 may facilitate communication between computing device 202, wearable 150, location sensor 220, management device 210, and/or managed devices 212.

In some examples, network 204 may include not just local physical networks but also software-defined networks (SDNs), virtual private networks (VPNs), or any architecture capable of facilitating communication and data transfer across geographically and/or logically dispersed locations. In some cases, network 204 may not be restricted to a single physically restricted network but can be a collection of interconnected networks that operate as a single entity by virtue of software control or through virtual connections. This arrangement can enable the user to cause a management action to be taken in a physically remote location, provided the devices are part of the same software-defined or virtual network.

Furthermore, the control of connected devices may not be limited to a single network. In some examples, actions triggered by a user gesture may result in a message being sent to another network where the corresponding action is taken based on the message received. In this way, network 204 represents any medium or architecture capable of facilitating communication, data transfer, or remote management of connected devices, across various physical or virtual networks.

In at least one example, computing device 202 may be a computing device programmed with one or more of modules 102. All or a portion of the functionality of modules 102 may be performed by computing device 202 and/or any other suitable computing system. As will be described in greater detail below, one or more of modules 102 from FIG. 1 may, when executed by at least one processor of computing device 202, may enable computing device 202 to provide personalized home automation.

Many other devices or subsystems may be connected to example system 100 in FIG. 1 and/or example system 200 in FIG. 2. Conversely, all of the components and devices illustrated in FIG. 1 and FIG. 2 need not be present to practice the embodiments described and/or illustrated herein. The devices and subsystems referenced above may also be interconnected in different ways from those shown in FIG. 2. Example system 100 and example system 200 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 3 is a flow diagram of an example method 300 for personalized home automation. The steps shown in FIG. 3 may be performed by any suitable computer-executable code and/or computing system, including example system 100 in FIG. 1, example system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 310, one or more of the systems described herein may receive (1) via a wearable device, biometric data associated with a wearer of the wearable device, and (2) from a management device communicatively coupled to at least one managed device, data representative of a device state of at least one managed device. For example, receiving module 104 may, as part of computing device 202 in FIG. 2, cause computing device 202 to receive, via wearable 150, wearer biometric data 208 and, from management device 210, device state 214 of at least one of managed devices 212.

As described above in connection with FIG. 1, a wearable device such as wearable 150 may include a device designed and/or intended to be worn by a wearer and/or integrated into clothing, such as a smart ring, a smart band, a smart watch, a smartphone, and so forth. FIG. 4. shows a perspective view 400 of an example smart ring device that may be used in connection with some embodiments of the systems and methods disclosed herein.

In some examples, biometric data such as wearer biometric data 208 may include and/or encompass various types of health and physiological information that can be obtained from a wearer of wearable 150. Hence, wearer biometric data 208 may include, but is not limited to, heart rate, blood pressure, body temperature, sleep patterns, physical activity levels, and stress levels. In certain instances, wearer biometric data 208 may also encompass more advanced metrics such as blood oxygen saturation, glucose levels, or even electrocardiogram (ECG) readings. The specific type and breadth of biometric data collected by wearable 150 can vary depending on the capabilities of wearable 150.

Components of either example system 100 and/or example system 200, such as modules 102, data store 140, and wearable 150, can collect, store, and/or analyze wearer biometric data 208. Wearer biometric data 208 may be gathered in real-time for dynamic insights into the current physiological state of wearer 206 or over time for historical insights into physiological changes of wearer 206.

Receiving module 104 may receive wearer biometric data 208 in a variety of contexts. For example, as shown in FIG. 2, computing device 202 and wearable 150 may be capable of communicating via network 204. Hence, wearable 150 may transmit wearer biometric data 208 to receiving module 104 via network 204. Additionally or alternatively, wearable 150 may transmit wearer biometric data 208 to data store 140, which may store wearer biometric data 208 for later use and/or analysis. Hence, in some examples, receiving module 104 may access wearer biometric data 208 from data store 140.

Management device 210 may facilitate communication and exchange of data between computing device 202 and managed devices 212. Management device 210 may be capable of receiving data, such as device state data, from one or more of managed devices 212. This information allows it to understand and monitor the current status of each of managed devices 212.

In some instances, the management device 210 may include a home automation management device and managed devices 212 may include one or more smart home devices including, without limitation, a smart speaker device, a smart lighting device, a smart switch, a security system, a home appliance, a networking device, a landscaping device, a home automation device, an internet of things (IOT) device, and/or an entertainment device. Hence, operations of management device 210 may include and/or involve directing a smart home device to perform a particular function, directing the device to transition between different operational states, directing the device to provide data regarding a present operational condition of the device, and/or or communicating device data to other parts of the system.

Device state 214 may include or represent any data representative of a condition or status of at least one of managed devices 212. By way of illustration, when one of managed devices 212 is a smart light switch, device state 214 may include or represent data that indicates a state of the smart light switch (e.g., activated, deactivated, an amount of activation, a location of the smart light switch, an identifier associated with a user of a smart home system who last interacted with the smart light switch, etc.).

Receiving module 104 may receive device state 214 from management device 210 in a variety of ways and/or contexts. For instance, as illustrated in FIG. 2, computing device 202 and management device 210 may have the capability to communicate via network 204. Consequently, management device 210 may transmit device state 214 to receiving module 104 via network 204. Alternatively or in addition, management device 210 may transmit device state 214 to data store 140, which may store device state 214 for subsequent use and/or analysis. Therefore, in some examples, receiving module 104 may access device state 214 from data store 140.

Returning to FIG. 3, at step 320, one or more of the systems described herein may determine, based on the biometric data, a current status of the wearer. For example, determining module 106 may, as part of computing device 202 in FIG. 2, cause computing device 202 to determine, based on wearer biometric data 208, wearer status 216.

Wearer status 216 may include a physical and/or physiological state of the wearer, and may include a broad range of health, wellness, and physiological parameters such as heart rate, body temperature, stress level, physical activity level, sleep state, etc. The specific parameters included in wearer status 216 can vary based on the capabilities of the wearable 150 and the type of biometric data it is capable of collecting and transmitting.

For instance, if wearable 150 can capture and transmit data on the wearer's heart rate and stress level, then wearer status 216 may include a “resting” status if the heart rate is within a normal resting range and the stress level is low, an “active” status if the heart rate is elevated indicating physical activity, or a “stressed” status if the stress level is high.

Determining module 106 may determine wearer status 216 in a variety of ways and/or contexts. For example, determining module 106 may determine wearer status 216 by analyzing wearer biometric data 208 received from wearable 150. Determining module 106 may use algorithms, models, or rules to interpret the data and derive meaningful information about the wearer's current physical and physiological state.

For instance, if wearer biometric data 208 includes heart rate and physical activity data, determining module 106 may compare these values to known thresholds or ranges to determine whether the wearer is at rest, exercising, or under stress. If sleep data is included, it might determine whether the wearer is awake, in light sleep, deep sleep, or REM sleep. The module could also consider combinations of data: for instance, a high heart rate combined with no physical activity may suggest the wearer is under stress.

In examples where the system collects data over time, determining module 106 may also use trend analysis and/or machine learning techniques to track changes and patterns in the wearer's status. For example, it may recognize patterns associated with daily routines, detect deviations from the norm, and/or identify long-term trends in health or activity levels.

In some examples, wearer status 216 may include a physical location of wearer 206. For example, one or more of modules 102 (e.g., determining module 106) may identify, via at least one location sensor (e.g., location sensor 220), a physical location of the wearer (e.g., physical location 222). Hence, in some examples, wearer status 216 may include physical location 222.

In some examples, location sensor 220 may include any component or device that may identify a physical location of a wearer of a wearable (e.g., wearer 206 of wearable 150). In some examples, location sensor 220 may be integrated into wearable 150. In additional or alternative examples, location sensor 220 may be part of another device that wearer 206 carries, such as a smartphone, smart wrist band, a smart tile, and so forth. Moreover, in some examples, location sensor 220 may include a device included in and/or integrated into an environment, such as a camera, a computer vision system, a Bluetooth™ beacon, a radio frequency identifier (RFID) reader, ultrasonic sensors, infrared sensors, and so forth.

Determining module and/or location sensor 220 may use a variety of technologies to identify physical location 222. For example, location sensor 220 may use GPS (Global Positioning System) to obtain precise, global coordinates, or it may use Wi-Fi or cellular triangulation for less precise, but still useful location information. In indoor environments, it might use technologies like Bluetooth beacons or Near Field Communication (NFC) to identify a proximity of wearer 206 to known locations.

Determining module 106 may use location information from location sensor 220 on its own, or combined with other data, to provide context for activities or states of wearer 206. For instance, physical location 222 could help differentiate between physical activity that occurs at a gym versus at an office, or it could trigger certain actions when the wearer enters or leaves a specific location.

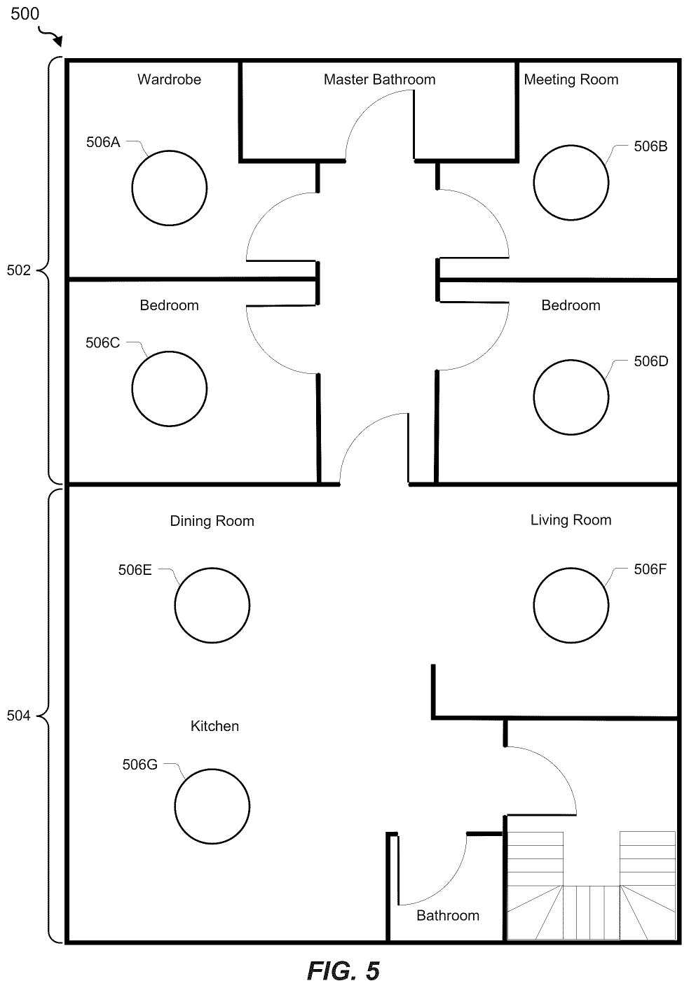

Determining module 106 may identify physical location 222 with varying degrees of accuracy. By way of illustration, FIG. 5 shows a floorplan 500 of an example smart home with a first zone 502 and a second zone 504. Various location indicators 506 (e.g., location indicator 506A through location indicator 506G) included in floorplan 500 indicate locations within first zone 502 and second zone 504.

Continuing with this illustration, if wearer 206 is in a kitchen of a home represented by floorplan 500, determining module 106 may identify physical location 222 of wearer 206 as any or all of (1) within the home represented by floorplan 500, (2) within second zone 504, and/or (3) at location indicator 506G.

In some examples, determining module 106 may identify physical location 222 using alternative methods when direct location data is unavailable. For instance, in scenarios where wearable 150 does not share its location, such as when GPS data is not provided, determining module 106 may leverage other network operational data to estimate physical location 222. By way of illustration, if wearable 150 is connected to a wireless network, a signal strength, along with other network characteristics, can provide valuable location data. The strength of the network signal between wearable 150 and an access point can help infer a distance between the two. Furthermore, if multiple access points are available, techniques such as triangulation can be used to estimate the location of the wearable more accurately. This way, even without explicit location data, determining module 106 may infer the wearer's physical location (e.g., physical location 222) based on network operational parameters, ensuring a continuous understanding of the wearer's physical location.

Determining module 106 may determine wearer status 216 dynamically in real-time or near-real-time, providing up-to-the-moment information about a physical and/or physiological state of wearer 206. Likewise, one or more of modules 102 (e.g., determining module 106) may track and/or analyze wearer status 216 over time to detect trends or patterns, which could provide deeper insights into the wearer's health and wellbeing.

As will be described in greater detail below, one or more of the systems disclosed herein may use wearer status 216 to adapt the operation of managed devices 212 to the current status of the wearer, creating a more personalized and responsive environment. For example, if wearer status 216 indicates the wearer is asleep, one or more of modules 102 (e.g., directing module 108) may direct management device 210 to dim the lights and/or adjust the thermostat for the night.

Returning to FIG. 3, at step 330, one or more of the systems described herein may direct, based on the current status of the wearer and the device state, the management device to execute a management action associated with the at least one managed device. For example, directing module 108 may, as part of computing device 202 in FIG. 2, cause computing device 202 to direct, based on wearer status 216 and device state 214, to execute management action 218 associated with at least one of managed devices 212.

A management action like management action 218 may include any directive or operation that directing module 108 may cause a computing device (e.g., computing device 202) to issue to a managed device (e.g., at least one of managed devices 212). A management action may alter a behavior or state of a managed device.

Management actions may vary depending on a managed device to which they are directed. By way of illustration, when one of managed devices 212 includes a smart thermostat, if the wearer status indicates the wearer is exercising and thus likely to be overheating, a management action may include a directive that directs the smart thermostat to lower the temperature. As an additional example, when one of managed devices 212 includes a smart lighting system, and the wearer status shows the wearer is sleeping, a management action may direct the smart lighting system to dim or turn off the smart lighting in the room.

As a further example, if the wearer status indicates the wearer is stressed, a management action might be to play calming music on a smart speaker. Additionally or alternatively, if the wearer's location data indicates they have left the home, a management action could be to arm a home security system. As another example, if the wearer's biometric data shows that they have just woken up in the morning, a management action could be to start brewing coffee on a smart coffee maker. By directing management device 210 to execute management actions based on a current status of the wearer and a device state, directing module 108 may ensure that a smart home system dynamically adapts to the wearer's needs and state, thereby increasing comfort and overall quality of life.

Directing module 108 may direct management device 210 to execute management action 218 in a variety of ways and/or contexts. For instance, as illustrated in FIG. 2, computing device 202 and management device 210 may have the capability to communicate via network 204. Consequently, directing module 108 may transmit an instruction to management device 210 that may instruct management device 210 to cause at least one of managed devices 212 to execute a management action 218.

In some examples, one or more components of example system 100 and/or example system 200 may be implemented via a cloud service. For example, one or more functions of computing device 202 and/or management device 210 may be performed by a cloud service that may interact with one or more managed devices.

A cloud service may include and/or refer to a variety of resources, applications, and services that may be delivered and accessed over the internet, rather than from local or on- premises hardware or infrastructure. These services are hosted and managed by third-party cloud service providers on large server networks, and they allow users to store and process data, run applications, and utilize other information technology resources remotely, using the provider's infrastructure. Key examples of cloud services include data storage and backup, web-based email services, hosted office suites and document collaboration services, database processing, managed technical support services, and more.

In some examples, one or more managed devices may be configured to interface with and/or be managed by a cloud service. In such examples, one or more components of example system 100 and/or example system 200 (e.g., management device 210) may be communicatively coupled to the at least one managed device via a cloud service application programming interface (API). A cloud service API may include a set of protocols, routines, and/or tools for securely interacting with cloud services. APIs define how different software components should interact and communicate with each other, effectively serving as a bridge between different software applications.

Cloud service APIs may allow managed devices (e.g., smart home devices) to communicate with the cloud, and vice versa, enabling functionality such as remote control of devices, data storage and retrieval, software updates, and interoperability with other devices and services. For example, a smart thermostat might use a cloud service API to send temperature data to a cloud service, receive commands from a user's mobile app, or interact with other smart devices in the home.

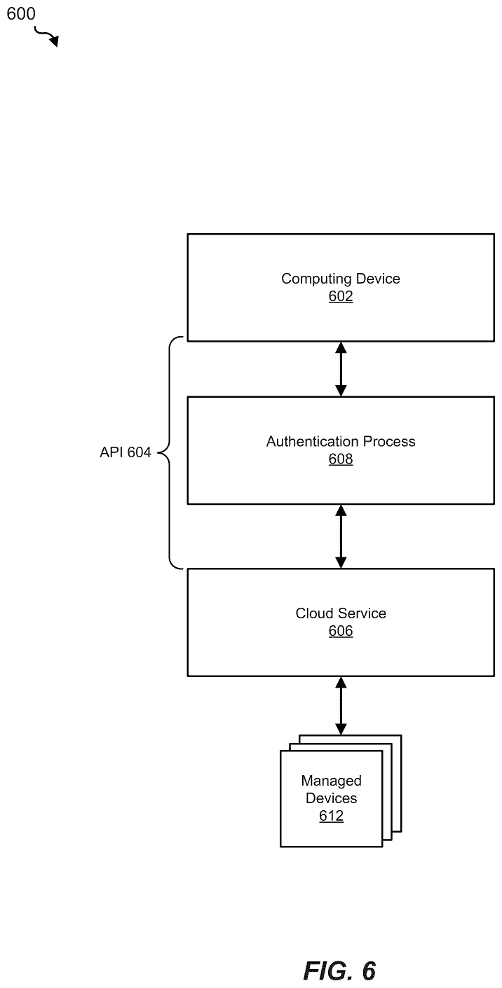

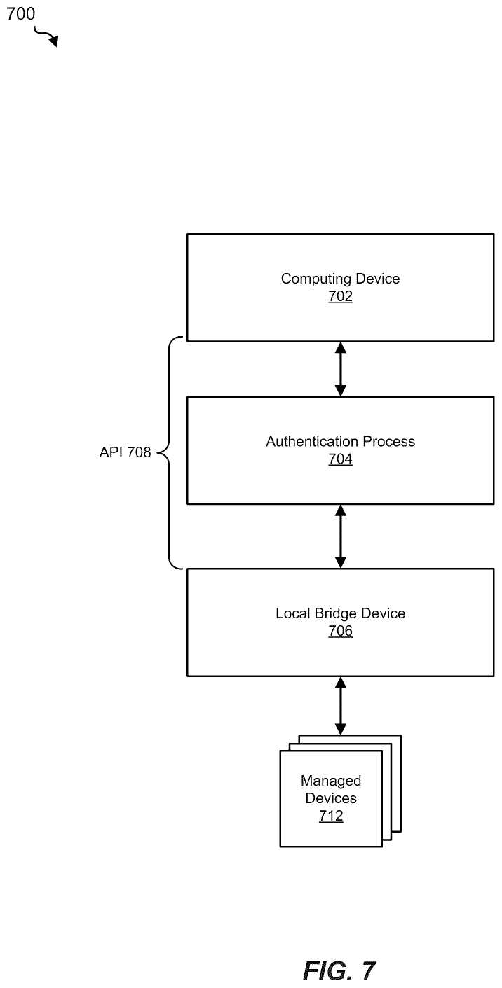

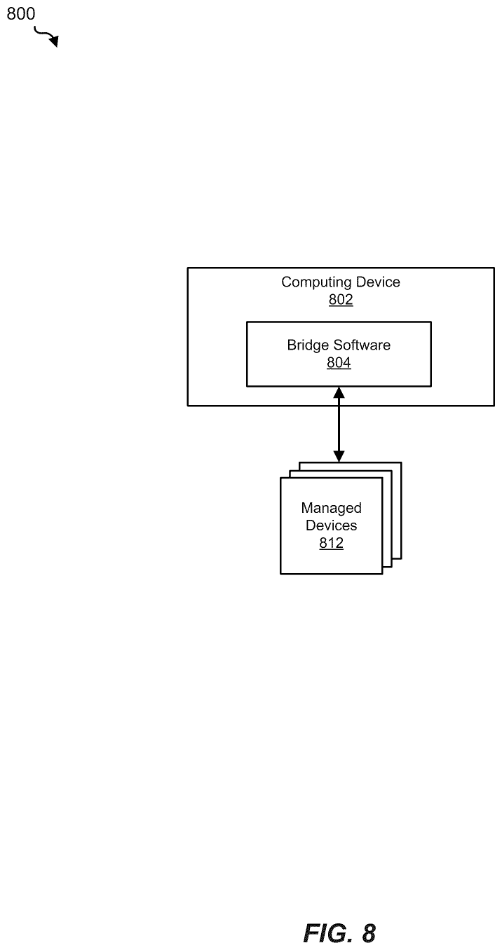

FIG. 6 is a block diagram 600 of a possible configuration for a system for personalized home automation wherein one or more functions of example system 100 and/or example system 200 may be implemented via a cloud service. As shown, FIG. 6 includes a computing device 602, a cloud service API 604, a cloud service 606, an authentication process 608, and managed devices 612. Computing device 602 may implement one or more functions of computing device 202 as described above, and managed devices 612 may include at least one managed device like managed devices 212.

As shown, computing device 602 is in communication with cloud service 606 via a cloud service API 604. Cloud service API 604 may include and/or may interface with an authentication process 608, which may represent an authentication process that may secure and/or authenticate communications between computing device 602 and cloud service 606. Hence, computing device 602 may, by interacting via cloud service API 604, authenticate with cloud service 606 by executing authentication process 608. Once authenticated, computing device 602 may interact with managed devices 612 via cloud service API 604 and cloud service 606.

In additional or alternative examples, one or more components of example system 100 and/or example system 200 may be implemented via a local bridge computing device. For example, one or more functions of computing device 202 and/or management device 210 may be performed by a local bridge computing device configured to interact with one or more managed devices.

In some examples, a “bridge computing device” or a “smart home bridge” may include a computing device that serves as a mediator or gateway between different types of devices, protocols, or networks within a smart home environment. One role of a bridge computing device is to facilitate communication between managed devices that might not directly communicate with each other due to differences in their communication protocols or standards.

For instance, a smart home might have devices that communicate using different protocols such as Zigbee, Z-Wave, Wi-Fi, or Bluetooth. A bridge computing device may be able to translate between these protocols, ensuring that the devices can communicate effectively with each other, and, as a result, function as part of a unified smart home system. In some cases, a bridge device may also allow managed devices within a smart home to connect to the wider internet, enabling remote access and control of managed devices. Such a bridge computing device may be implemented via software or hardware and may be implemented via local computing hardware and/or one or more cloud services.

FIG. 7 is a block diagram 700 of a possible configuration for a system for personalized home automation wherein one or more functions of example system 100 and/or example system 200 may be implemented via a local bridge device. As shown, FIG. 7 includes a computing device 702, an authentication process 708, a local bridge device 706, and managed devices 712. Computing device 702 may implement one or more functions of computing device 202 as described above, and managed devices 712 may include at least one managed device like managed devices 212.

As shown, computing device 702 is in communication with local bridge device 706 via an API 704. API 704 may include and/or may interface with an authentication process 708, which may represent an authentication process that may secure and/or authenticate communications between computing device 702 and local bridge device 706. Hence, computing device 702 may, by interacting via API 704, authenticate with local bridge device 706 by executing authentication process 708. Once authenticated, computing device 702 may interact with managed devices 712 via local bridge device 706. Hence, directing module 108, as implemented by computing device 702, may direct local bridge device 706 to execute a management action associated with at least one of managed devices 712 via the local bridge device 706.

As mentioned above, in some examples, a bridge computing device may be implemented as software and executed by a suitable general or specialized computing device (e.g., computing device 202). Bridge software may include or represent software that facilitates the communication and integration between different devices, protocols, or systems, much like a physical bridge device. However, instead of being a physical device, this is a software solution may be installed on a device in a network (e.g., network 204), such as a router, hub, or even a dedicated computing device.

As with a physical bridge device, bridge software may operate by translating commands and data between different protocols, thereby enabling managed devices that use differing communication standards to interact with each other. For instance, in a smart home context, bridge software could enable a smart thermostat using Wi-Fi to communicate and work in tandem with a smart lighting system using Zigbee. Similarly, bridge software may provide a means for cloud-based services (like a voice assistant) to interact with local managed home devices.

FIG. 8 is a block diagram 800 of a possible configuration for a system for personalized home automation wherein one or more functions of example system 100 and/or example system 200 may be implemented via bridge software. As shown, FIG. 8 includes a computing device 802 that includes bridge software 804 that is in communication with managed devices 812. Computing device 802 may implement one or more functions of computing device 202 as described above, and managed devices 812 may include at least one managed device like managed devices 212. In this example, directing module 108, as implemented by computing device 802, may direct bridge software 804 to execute a management action associated with at least one of managed devices 812 via bridge software 804.

As may be clear from the foregoing, embodiments of the systems and methods disclosed herein may provide many benefits over conventional or traditional automation systems. For example, embodiments of the systems and methods disclosed herein may leverage data gathered from a wearable device for intuitive and automated home management. In contrast, traditional home automation systems may require manual inputs or pre-set schedules to control IoT devices. This approach, while functional, does not take into account the real-time status or activities of the user, leading to suboptimal performance and potential inconvenience. For instance, pre-set schedules for locking doors or adjusting window shades do not account for variations in user daily routines.

In contrast, embodiments of the systems and methods disclosed herein build upon an understanding that a truly smart home should adapt to the user's needs dynamically and intuitively. This is achieved through the integration of data gathered via a wearable device such as a smart ring. By utilizing this data, embodiments may accurately determine a status of the wearer, such as whether the user is asleep or awake, and accordingly adjust various IoT devices in the home. This offers a level of customization and user-centric automation that surpasses conventional systems.

Various implementations are proposed for the execution of this system, ranging from utilizing third-party cloud services to local implementations via a home PC or company-hosted IoT bridge software. Each of these implementations is designed with a focus on user data security and ensuring access control to IoT devices.

The incorporation of machine learning algorithms may allow the system to continually learn and refine its understanding of the user's behaviors and preferences over time, further improving the efficiency and user-centricity of the automation.

Thus, embodiments of this disclosure may introduce significant improvements over traditional systems, leading to considerable enhancements in user convenience, energy efficiency, and personal safety. Hence, the systems and methods disclosed herein present a new standard for personalized home automation, moving closer to the ideal of truly smart homes that can adapt dynamically to the user's needs.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive gesture input data to be transformed, transform the gesture input data, output a result of the transformation to identify a gesture executed by a wearer of a wearable device, use the result of the transformation to direct a management device to execute a management action, and store the result of the transformation to track a history of gesture input. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems. In some examples, non-transitory-type media may be referred to as a non-transitory computer-readable medium.

Embodiments of the instant disclosure may include or be implemented in conjunction with an artificial reality system. Artificial reality is a form of reality that has been adjusted in some manner before presentation to a user, which may include, e.g., a virtual reality

(VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving:
via a wearable device, biometric data associated with a wearer of the wearable device;
from a management device communicatively coupled to at least one managed device, data representative of a device state of the at least one managed device;
determining, based on the biometric data, a current status of the wearer; and
directing, based on the current status of the wearer and the device state, the management device to execute a management action associated with the at least one managed device.

2. The computer-implemented method of claim 1, wherein the computer-implemented method further comprises identifying, via at least one location sensor, a physical location of the wearer.

3. The computer-implemented method of claim 2, wherein determining the current status of the wearer is further based on the physical location of the wearer.

4. The computer-implemented method of claim 2, wherein directing the management device to execute the management action associated with the at least one managed device is further based on the physical location of the wearer.

5. The computer-implemented method of claim 1, wherein the management device comprises a home automation management device and the at least one managed device comprises a smart home device.

6. The computer-implemented method of claim 5, wherein the home automation management device executes the management action by directing the smart home device to execute a smart home function.

7. The computer-implemented method of claim 6, wherein the smart home device comprises at least one of:
a smart speaker device;
a smart lighting device;
a smart switch;
a security system;
a home appliance;
a networking device;
a landscaping device;
an Internet of Things (IOT) device; and
an entertainment device.

8. The computer-implemented method of claim 6, wherein directing the smart home device to execute the smart home function comprises at least one of:
directing the smart home device to transition from a first operational state to a second operational state;
directing the smart home device to provide data regarding a present operational condition of the smart home device to the management device; and
directing the home automation management device to present the data regarding the present operational condition of the smart home device via an output device.

9. The computer-implemented method of claim 1, wherein:
the management device is communicatively coupled to the at least one managed device via a cloud service application programming interface (API); and
directing the management device to execute the management action associated with the at least one managed device comprises directing the management device to execute the management action associated with the at least one managed device via the cloud service API.

10. The computer-implemented method of claim 1, wherein:
the management device is communicatively coupled to the at least one managed device via a locally hosted bridge computing system; and
directing the management device to execute the management action associated with the at least one managed device comprises directing the management device to execute the management action associated with the at least one managed device via the locally hosted bridge computing system.

11. The computer-implemented method of claim 1, wherein the wearable device comprises a smart ring device.

12. A system comprising:
a receiving module, stored in memory, that receives:
via a wearable device, biometric data associated with a wearer of the wearable device;
from a management device communicatively coupled to at least one managed device, data representative of a device state of the at least one managed device;
a determining module, stored in memory, that determines, based on the biometric data, a current status of the wearer;
a directing module, stored in memory, that directs, based on the current status of the wearer and the device state, the management device to execute a management action associated with the at least one managed device; and
at least one physical processor that executes the receiving module, the determining module, and the directing module.

13. The system of claim 12, wherein the determining module further identifies, via at least one location sensor, a physical location of the wearer; and at least one of:
the determining module further determines the current status of the wearer based on the physical location of the wearer; and
the directing module directs the management device to execute the management action associated with the at least one managed device further based on the physical location of the wearer.

14. The system of claim 12, wherein:
the management device comprises a home automation management device;
the at least one managed device comprises a smart home device; and
the home automation management device executes the management action by directing the smart home device to execute a smart home function.

15. The system of claim 14, wherein the directing module directs the smart home device to execute the smart home function by at least one of:
directing the smart home device to transition from a first operational state to a second operational state;
directing the smart home device to provide data regarding a present operational condition of the smart home device to the management device; and
directing the home automation management device to present the data regarding the present operational condition of the smart home device via an output device.

16. The system of claim 12, wherein:
the management device is communicatively coupled to the at least one managed device via a cloud service application programming interface (API); and
the directing module directs the management device to execute the management action associated with the at least one managed device by directing the management device to execute the management action associated with the at least one managed device via the cloud service API.

17. The system of claim 12, wherein:
the management device is communicatively coupled to the at least one managed device via a locally hosted bridge computing system; and
the directing module directs the management device to execute the management action associated with the at least one managed device by directing the management device to execute the management action associated with the at least one managed device via the locally hosted bridge computing system.

18. A non-transitory computer-readable medium comprising computer-readable instructions that, when executed by at least one processor of a computing system, cause the computing system to:
receive:
via a wearable device, biometric data associated with a wearer of the wearable device;
from a management device communicatively coupled to at least one managed device, data representative of a device state of the at least one managed device;
determine, based on the biometric data, a current status of the wearer; and
direct, based on the current status of the wearer and the device state, the management device to execute a management action associated with the at least one managed device.

19. The non-transitory computer-readable medium of claim 18, wherein the computer-readable instructions, when executed by the at least one processor of the computing system, further cause the computing system to:
identify, via at least one location sensor, a physical location of the wearer; and at least one of:
determine the current status of the wearer based on the physical location of the wearer; and
direct the management device to execute the management action associated with the at least one managed device further based on the physical location of the wearer.

20. The non-transitory computer-readable medium of claim 18, wherein:
the management device comprises a home automation management device and the at least one managed device comprises a smart home device;
the management device comprises a home automation management device;
the at least one managed device comprises a smart home device;
the home automation management device executes the management action by directing the smart home device to execute a smart home function;
the computer-readable instructions, when executed by the at least one processor of the computing system, further cause the computing system to direct the smart home device to execute the smart home function by at least one of:
directing the smart home device to transition from a first operational state to a second operational state;
directing the smart home device to provide data regarding a present operational condition of the smart home device to the management device; and
directing the home automation management device to present the data regarding the present operational condition of the smart home device via an output device.
